(19) United States
(12) Patent Application Publication
(10) Pub. No.: US 2012/0254967 A1
(43) Pub. Date: Oct. 4, 2012

(54) EXTERNAL DEVICE HAVING AT LEAST ONE MEMORY

(76) Inventor: Uwe Peter Braun, Potsdam (DE)

(21) Appl. No.: 13/516,498

(22) PCT Filed: Dec. 10, 2010
(86) PCT No.: PCT/EP10/07548

§ 371 Date: Jun. 15, 2012

(30) Foreign Application Priority Data
Dec. 18, 2009 (DE) 10 2009 059 077.3
Aug. 26, 2010 (EP) 10174186.6

(51) Int. Cl. G06F 21/20

(52) U.S. Cl. 726/7; 726/5

(57) ABSTRACT

The invention relates to an external device (100) having at least one memory, which device can be connected with a computer (24) or computer network by way of a serial bus system. In order to make available an external device (100) that can be used to provide increased protection against access by unauthorized persons to security-relevant regions and sensitive data in computers (24) and computer networks, the invention provides that the external device (100) has a processor (14) as well as a USB drive (15) and a biometric means (12b) for identification of a person, wherein processor (14), USB drive (15), and biometric means (12b) are coupled with one another.

The invention relates to an external device having at least one memory, which device can be connected with a computer or computer network by way of a serial bus system. Furthermore, the invention relates to a method for verification of the access entitlement of a user of a computer or computer network.

### STATE OF THE ART

External devices of the type stated initially are known from the state of the art and are used, particularly in the form of USB sticks, as a memory. They particularly fulfill the function of a hard drive, whereby the data are electronically stored on a memory, particularly on what is called a flash drive.

Conventional USB sticks are designed in such a manner that a USB plug that extends from a front end of the circuit board of the stick is exposed, in that it projects out of the opening of the USB stick housing.

Furthermore, USB sticks are known, which are provided with corresponding software to ensure secure data storage and for the purpose of avoiding data misuse.

For this purpose, a USB stick previously known from DE 10 2009 007 345 A1 having a security control is connected with a USB interface that has a connection with a modifiable data medium chip. In this manner, data that are supposed to be stored on a memory chip can be encrypted using the security control. Furthermore, the previously known security control is used in a USB stick to connect a data medium or memory chip with the USB, interface, whereby the data medium is inserted into the USB stick. The device and method in DE 10 2009 007 345 A1 represent approaches for providing data security by means of a USB stick and for preventing data misuse.

However, it is a disadvantage of these previously known devices that they merely represent an instrument for secure storage of data on USB sticks. In the recent past, in particular, protection of computers and networks against attacks from the Internet or against impermissible access, both from internal and from external sources, has gained importance, however, due to increased cases of data misuse.

Presentation of the Invention: Task, Solution, Advantages

It is therefore the task of the invention to make available an external device of the type stated initially, which can be used to provide increased protection against access by unauthorized persons to security-relevant regions and sensitive data in computers and computer networks.

This task is accomplished with the characteristics of claim 1. Advantageous embodiments of the invention are manifested in the dependent claims.

According to the invention, the external device, which is also referred to as a transaction key in the terminology used, has a processor as well as a USB drive and a biometric means for identification of a person, whereby processor, USB drive, and biometric means are coupled with one another.

It is the core idea of the invention that verification or access entitlement takes place, after the external device is inserted into a USB interface, by means of biometric detection that guarantees exact identification.

For this purpose, the physiological characteristic of the user is stored on the USB drive and/or in the computer or in the computer network beforehand, so that the recorded and recognized physiological characteristic can be directly compared with the stored data of the physiological characteristic, preferably internally. A comparison also takes place within the external device, with the flash memory and the ID chip, as well as the physiological characteristic, whereby the data are then sent to the server (computer network). The physiological characteristic, which is preferably a fingerprint, is read in by way of the biometric means, which is preferably a fingerprint sensor, and compared with the biometrical data stored on the USB drive, by way of the processor of the external device. Thereupon a memory of the external device, which memory is preferably present as a working memory, delivers the confirmation to a computer or a computer network for comparison, whereupon the computer in turn sends a signal back to the processor of the external drive, in the event of a positive comparison, so that the processor can send a corresponding code back directly to the computer or to the computer network. A corresponding computer program is provided for implementation of this verification technique.

In this way, the device according to the invention offers efficient access protection for computers, laptops, or other mobile computer-related devices, such as, for example, netbooks, smartphones, or also mobile telephones. Furthermore, the device according to the invention offers secure protection for entire computer networks such as those that are used in research and development facilities, for example. In this connection, the access protection can extend to cover the entire system, for example the computer or the network. The device according to the invention thus also offers the possibility of secure remote access (Secure Remote Access) to a network, for example a corporate network, computer network of a research facility, or a university network. Furthermore, the device according to the invention allows a VPN (Virtual Private Network) connection, for example. This offers the advantage that no additional software installation or setting has to be undertaken beforehand, in order to set up a VPN connection from a laptop, for example, to a corporate network. With the device according to the invention, a VPN connection to a secured network can be established without any additional software setting, from any location, after successful user identification. Furthermore, it is possible to protect specific regions within the system against impermissible access by means of the device according to the invention. For this purpose, the access rights can be defined or set as a function of the users or user groups, in accordance with the application case, in each instance. It is therefore possible for individual users to be given access to individual regions in the system, or for users to have access to previously defined data, data regions, or also computer programs.

According to the invention, the external device has an encryption unit. Therefore encrypted and non-encrypted regions on a hard drive or on another data medium as well as partitions on multiple hard drives of a computer system can be administered and protected against impermissible access. Furthermore, access to different operating systems of a system can be regulated for the various users, using the external device. Thus the use of the device according to the invention offers effective protection against impermissible access from the Internet both internally and externally. Also, the invention offers protection against viruses.

It is advantageous if the device according to the invention has an RFID (Radio Frequency Identification) chip. This RFID chip, which serves for identification using electromagnetic waves, allows the implementation of additional functions such as door openers, detection of persons, or access monitoring.

Furthermore, it is preferred that the external device has a temperature sensor. The use of a temperature sensor increases the security when reading in a fingerprint. In this way, for example, possible copies of a fingerprint can be differentiated from an actual fingerprint, and recognized.

Preferably, the external device furthermore has a proximity sensor. By means of such a proximity sensor, it can be determined, for example, whether a person is moving or situated in the area of a computer. Therefore additional detection of persons by means of a proximity sensor is also possible. Furthermore, it is possible to control the energy-saving mode of the computer system by means of the proximity sensor. For example the computer can be brought into a specific energy-saving mode if the user steps away from the computer or if no person is situated in the area of the computer. For security reasons, the computer should automatically log off after the user goes away, preferably within a short time window, for example within one minute.

It is advantageous if the device according to the invention has an ID identification unit. This ID identification unit serves for the generation of identification codes. In this connection, it is provided to generate worldwide unique identification codes having a length of 48 bits, using the ID identification unit. Shorter or longer identification codes can also be generated. A special neuron chip serves for generation of these identification codes. Alternatively, this neuron chip could also be replaced by a microprocessor, such as, for example, an ARM processor, and the identification code can be generated using a special protocol, for example LON-Talk protocol. In this connection, LON stands for Local Operating Network. LON is a field bus frequently used in automation technology, which is specified by the international standard ISO/IEC 14908. The identification code that is generated, just like the physiological characteristic, is read and verified by the microcontroller of the external device. For this purpose, the microcontroller of the external device compares the identification code as well as the physiological characteristic with information or data that have been stored beforehand. For further identification by the computer or the computer network, the identification code, together with the physiological characteristic, is sent to the computer or computer network in encrypted or coded form. Finally, the computer or a target server of the computer network compares the transmitted physiological characteristic as well as the transmitted identification code with the data stored in the computer or in the computer network.

Preferably, the device according to the invention furthermore has a wireless interface. This wireless interface is preferably a serial wireless connection such as WLAN or Bluetooth, for example. In this connection, the wireless interface can be provided in addition to the hard-wired serial interface, for example USB interface, in the device according to invention. Alternatively, the wireless connection can also replace the hard-wired interface, for example USB interface. In every case, the device according to the invention provides for sending all the data required for verification or identification to the computer or computer network by way of the wireless interface, as well. Accordingly, the wireless interface, just like the USB interface, for example, serves for transmission of the physiological characteristic as well as of the identification codes to the computer or computer network, for final identification. Furthermore, possible hierarchies, for example user-related hierarchies or rights, can be newly issued or changed by way of this interface, after identification has taken place. In addition, it is possible to transmit additional data between computer and external device by way of this wireless interface. In this connection, this can involve not only further security-relevant data but also configuration or administrative data. Also, this wireless interface can serve to clearly identify a user with another device, for example an automatic teller machine, using this device according to the invention.

Furthermore, it is preferred that the device according to the invention has a power supply unit. In this connection, the power supply unit consists of a small charging buffer, for example a rechargeable battery or battery, which is provided in the external device, as well as, preferably, an additional, more powerful rechargeable battery, which is situated in the protective cap (for example the cap of the USB stick), for example. Preferably, the external device has a real-time clock that can therefore be constantly supplied with voltage by way of the charging buffer. When the external device is operated by way of the hard-wired interface, for example USB interface, the power supply is provided by the computer, by way of this interface. Furthermore, it is provided to use this interface for charging the charging buffer as well as the additionally provided rechargeable battery. For this purpose, the rechargeable battery that is situated in the protective cap of the device, for example, is connected with the external device for charging, in suitable manner, during operation by way of the USB interface. In addition to the possibility of charging by way of the USB interface, charging with an external power supply is also provided. This is particularly needed when using the device according to the invention by way of the wireless interface, for example WLAN or Bluetooth. Depending on the capacity of the additional rechargeable battery, operation by way of the wireless interface can also take place over a longer period of time, without use of an external power supply.

Preferably, the device according to the invention is configured in such a manner that it also has user data, in addition to the security-relevant data required for identification, using an internal memory. For this purpose, it is advantageous if the external device has an additional flash module, for example a NOR flash module. Depending on the scope of the user data to be stored, as well as their organization, a different memory, for example a NAND flash module, could also be used. All user-dependent data, such as desktop data, for example, can be saved as user data. This offers the advantage, for example, that every user can define data desired or frequently used by him/her, for example, and save them on the external device. For example, in this way the background color of the screen or also frequently used programs and data can be made quickly accessible to the user, after identification has taken place, by means of links for the user. Furthermore, hierarchy data, such as user-related rights, for example, can be stored.

It is the advantage of the invention that all security-relevant data are saved and stored on the external device, to which the user has access at any time, so that maximal security is guaranteed. Furthermore, it is also possible, according to the invention, that a suitable password as well as a physiological characteristic of the user is sufficient for starting a computer or computer network. Also, the invention guarantees complete encryption, for example of the hard drive, of the work station as well as of the computer network.

A computer program for a computer facility in the form of a computer or a computer network that is connected with the external device is provided in claim 21, whereby the computer program is implemented on the computer or computer network and contains an algorithm that is processed by a processor of the computer facility when a connection exists between the computer facility and the external device, whereby the algorithm covers the method.

Furthermore, the invention provides for a method for verification of access entitlement of a user of a computer or of a computer network, in which method biometric data of the user can be detected and recognized for verification, by means of a biometric means of an external device according to one of claims 1 to 16 connected with the computer or computer network.

The dialog by way of a serial bus system is important within the scope of the invention, because the data cannot be deleted, downloaded, or displaced on the program plane of the computer, the computer network, the system landscape, etc., and therefore the contents of the program plane experience confidentiality and the user can securely configure a research plane, for example, with worldwide networking, in this manner. The term serial bus system is understood to mean not only hard-wired connections, for example USB, Ethernet, or SATA, but also wireless connections, such as WLAN or Bluetooth.

For verification of access entitlement, or for identification of a user with a computer or with a computer network, the device according to the invention is connected with a computer or a computer network or a system landscape by way of a hard-wired interface, for example USB interface, or a wireless interface, for example WLAN or Bluetooth. After successful connection, a physiological characteristic, for example a fingerprint, of the user is read by means of the external device. For this purpose, the user passes or lays his/her finger over or onto a fingerprint sensor on the external device. Afterward, the physiological characteristic, for example the fingerprint, is compared with data of the fingerprint of the user previously saved within the device, and the user is thereby identified. Furthermore, the internally generated identification code is read by the microprocessor of the external device and compared with previously saved data. Afterward, not only the fingerprint but also the identification code is transmitted to the computer or computer network or system landscape in encrypted form, by way of the USB interface or the wireless interface. Subsequently, the computer or the target server of the computer network or of the system landscape compares the received data with the data stored there, the physiological characteristic of the related user as well as the related identification code. After agreement of the data has been determined, a password or a personal PIN can additionally be queried, to increase security. After successful identification, the user is given access to specific data of the computer or of the computer network or of the system landscape, as well as rights for using specific programs on the computer or in the network. In this connection, the rights and data that are accessible to a user can be defined as a function of the user or also of a certain group affiliation, as well as other criteria. These access rights can be changed at any time. When the connection between external device and computer or computer network is cut, access to the data or the software is interrupted immediately. In this way, it is ensured that when the external device is removed from the USB port, or if the external device is removed outside the range of the wireless connection, access to the data or to the software is interrupted immediately. If a renewed connection is made again subsequently, the identification process described above must be undertaken again.

According to the invention, the external device is connected with the interface of the computer, whereupon the computer program previously installed is initialized and sign-on is put into motion in this program plane. The computer can be operated like a conventional computer without the external device, whereby, however, the computer program is not addressed. In this connection, it is not possible to access the computer program without the external device, not even by way of the Internet/Intranet. Preferably, the hard drive of the computer network can be secured with the external device, in that the bus line and data line of the overall system of computer/computer network and external device is completely encrypted again in the overall system, with the external device. This can be implemented by way of system software in that the CPU, control unit and execution unit in the computer the data and bus lines are encrypted according to the same principle.

As soon as the computer program has been installed on the ROM memory and RAM working memory, the computer program can secure computer, network, system landscape in such a manner that it accesses the control unit and execution unit in the processor of the computer directly, in that the external device is connected with an interface for peripheral device units. Here, the external device transmits an IP address that can be read by the control unit of the computer. Only once the control unit has confirmed the transmitted IP address is the system started automatically.

The computer program according to the invention is installed on the computer or computer network so that it functions as an operating system for the external device with the computer, network, system landscape, etc. Afterward, the initialization process is started automatically, and the request to place the user's fingerprint on the fingerprint sensor is displayed. Then successful initialization is confirmed, or repetition is requested.

### BRIEF DESCRIPTION OF THE DRAWINGS

An exemplary embodiment of the invention will be explained in greater detail below, using the drawings. These show, in a schematic representation:

FIG. 1 a construction form of the external device according to the invention;

FIG. 2 the technical structure of the external device from FIG. 1;

FIG. 3 the data sequence in the external device from FIG. 2;

FIG. 4 the essential components of a computer; and

FIG. 5 a block schematic of the external device.

### PREFERRED EMBODIMENT OF THE INVENTION

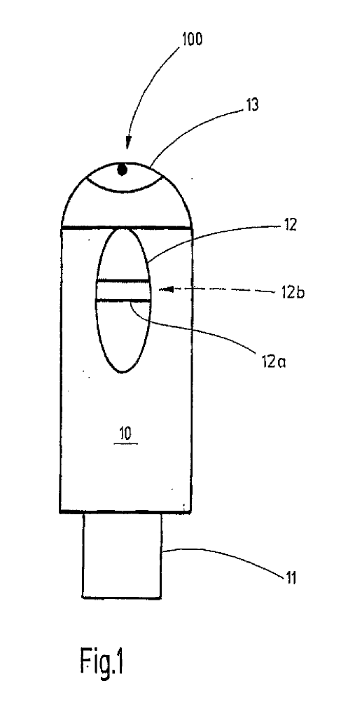

FIG. 1 shows a construction form of the external device according to the invention, which is provided with the reference symbol 100.

The external device 100 has the construction form of a USB stick and is provided with a USB plug 11 at one end, which plug is exposed, in that it projects from an opening in the housing 10. The USB plug 11 is suitable for being introduced into a USB port, for example of a computer.

The external device 100 furthermore has a biometric means 12b in the form of a fingerprint sensor 12 as well as a proximity sensor 13, which are integrated, in whole or in part, into the housing 10. The fingerprint sensor 12 is disposed in such a manner that the user of the external device 100 can place his/her finger onto the scanner surface 12a, so that the fingerprint sensor 12 can detect the fingerprint and the latter can be recognized.

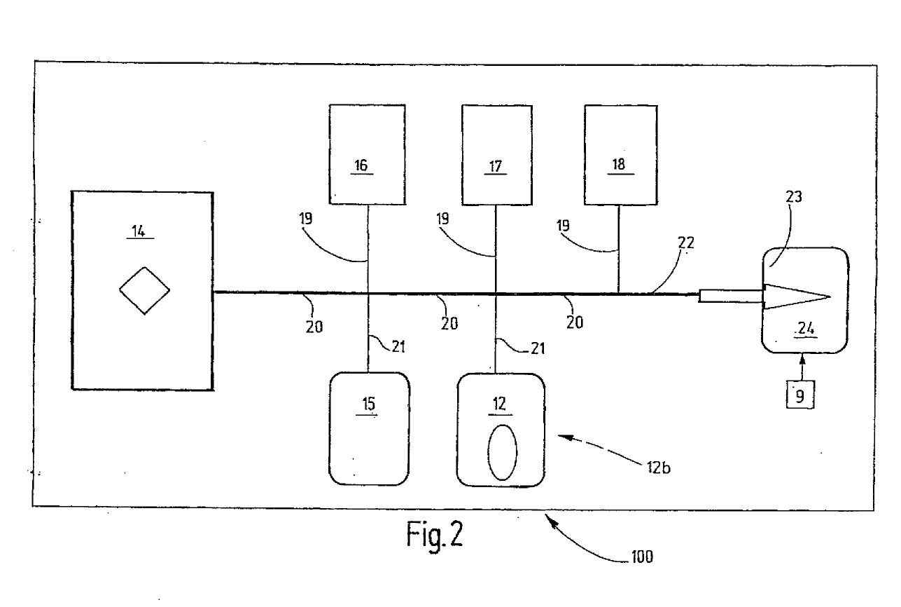

FIG. 2 shows the technical structure of the external device 100. Aside from the plug 11 shown in FIG. 1, the device 100 has the USB drive 15, which, along with the fingerprint sensor 12 and the processor 14, which is present as a microprocessor, belong to the essential components of the external device 100.

After detection of the fingerprint of the user of the device 100 by way of the fingerprint sensor 12 shown in FIG. 1, the fingerprint is read in and compared with the biometric data previously stored in the USB drive 15. Before that, further components shown in FIG. 2 are involved in the process, namely the processor 14, the working memory (RAM) 17, as well as the fixed-value memory (ROM) 16, in that when the external device 100 is inserted into the USB interface 23 of a computer 24, in a computer program 9 previously implemented in the computer 24, the computer 24 requests the user to place his/her fingerprint on the fingerprint sensor 12, so that detection can take place and the fingerprint sensor 12 can transmit a digital code to the processor 14 of the external device 100, whereupon the working memory 17 and the memory are activated.

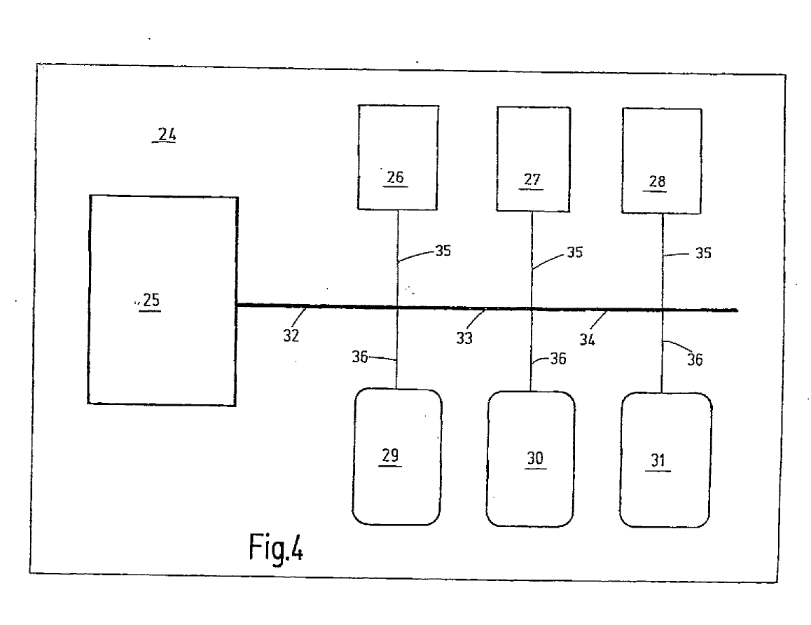

The fixed-value memory 16 and/or the working memory 17 of the external device 100 now access the USB drive 15 of the external device 100 and compare the biometric data with the fingerprint that was already stored by way of corresponding software during implementation. After this process has been concluded, the processor 25 of the computer 24 shown in FIG. 4 accesses the fixed-value memory 26 and the working memory 27 of the computer 24 and compares the fingerprint of the user already stored in the working memory 27. As the next thing, the processor 25 of the computer 24 shown in FIG. 4 transmits an initialization code back to the processor 14 of the external device 100 shown in FIG. 2. Only now does the processor 14 of the external device 100 generate a log-in code to the processor 25 of the computer 24, so that the overall system, i.e. computer 24 and external device 100, is switched clear.

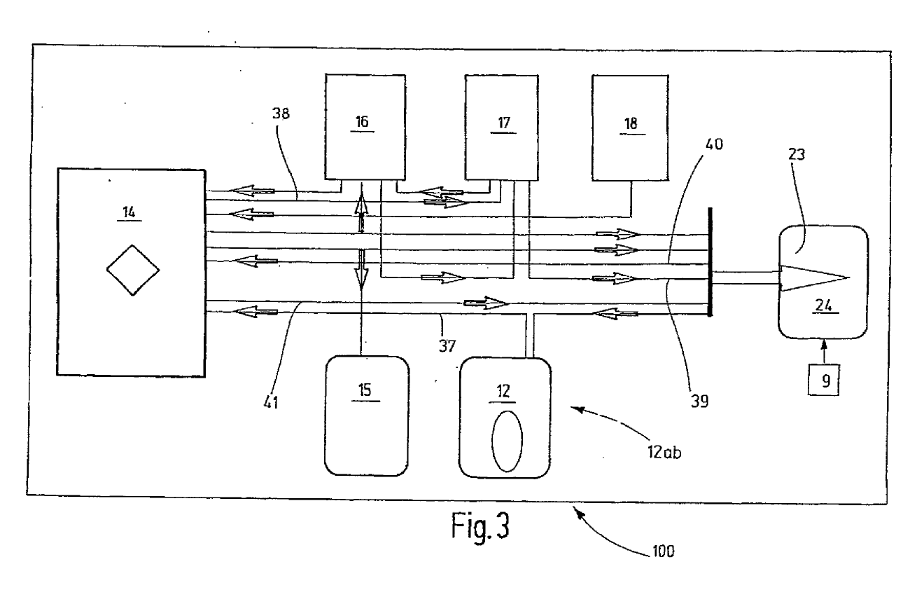

This relationship is also evident once again from FIG. 3 which shows the data sequence within the external device 100. The fingerprint detected by the fingerprint sensor 12 is read in, and the digital code of the fingerprint is transmitted to the processor 14 by way of the connection 37. From there, the working memory 17 and the statistical memory are activated by way of the connections 38; these then access the USB drive 15 by way of data lines, and compare the biometric data of the fingerprint already stored in the USB drive 15 by means of a corresponding computer program. The working memory 17 delivers a corresponding determination to the computer 24 by way of the data line 39. The computer 24 in turn delivers a signal to the processor 14 of the external device 100 by way of the data line 40, after a positive comparison of the data, whereupon the processor 14 transmits a code back directly to the computer 24, by way of the data line 41. After identification, the computer 24 transmits the release by way of the data line 40. If identity parity exists, access to the computer 24 is then finally released.

As is further evident from FIG. 2, the external device 100 furthermore has a WLAN connection 18 that allows remote programming of the system conditions. The individual components in the external device 100 are connected with one another by way of data lines 19, 20, 21, 22.

Furthermore, as shown in FIG. 4, the computer 24 can also be provided with other peripheral devices 29, 30, 31, as well as with an input/output 28. The components of the computer 24 shown in FIG. 4 are connected with one another by way of data lines 32, 33, 34, 35, 36.

Preferably, as shown in FIG. 2, the fast USB drive 15 is connected with the working memory 17, as a fast cache (work register), because the processor 14 has a smaller working memory. The processor 14 furthermore assigns the IP addresses of the data and bus lines and in this way organizes the planned hierarchy on the program network of the computer 24 of the user. For this purpose, as well, the processor 14 accesses the working memory 17 and the USB drive 15. An RFID chip of the external device 100, not shown in FIG. 1 to 4, furthermore recognizes security regions and detects the users of the external device 100 and preferably already registers the user still to be logged on with his/her biometric data in the program network of the computer 24.

The energy supplied to the external device 100 can come, for example, from the computer 24 by way of the serial interface 23 shown in FIG. 2, or by way of a battery or cell. In the embodiment of the external device 100 shown in FIG. 2, the energy is supplied by way of a battery buffer.

After reboot and logging on to the computer 24, previously established encryption automatically starts in the external device 100. The encryption takes place by way of the biometric data comparisons, as a first access, for example to the computer program of the computer network, and afterward by way of the working memory 17 of the external device 100 shown in FIG. 2, as well as the working memory 27 of the computer 24 shown in FIG. 4.

In this connection, the external device 100 has a working program that organizes the hierarchies of the individual users. This hierarchy program is loaded into the working memory 27 of the computer 24. The external device 100 thereupon delivers IP addresses to the system program of the computer 24, whereupon the program opens and is accessible to the user, depending on the stored hierarchy. In this connection, encryption takes place both on the external device 100 and on the computer 24. The bus lines and data lines are controlled by way of a corresponding computer program that is implemented on the computer 24.

The creation of the encryption takes place, after the biometric data comparison, in such a manner that first, the external device 100 transmits an IP address to the computer 24 in which the hierarchy program is stored. The hierarchy program in turn automatically resets an IP address. The external device 100 thereupon transmits a numerical code generated by a random generator, whereby the recognized numerical code is transmitted back to the external device 100. The working program then opens up a development platform. In this connection, the first IP address has already transmitted the hierarchy level of the detected biometric data of the user as part of the transmission, so that the development program now automatically opens in an allowed raster. In this connection, the data on the development program cannot be deleted or downloaded. A “remove on reboot” program remembers to delete or download these applications and removes or loads the file requests during the next restart of the computer 24, but only after release by the system administrator. Afterward, the desired file is deleted or desired data are made available to the user on the Internet/Intranet. In this way, it is ensured that the data cannot be displaced or possibly lost. It must be noted that encryption can only be permitted if the external device 100 is situated in the interface 23 of the computer 24. Consequently, encryption only starts automatically after the reboot and after logging in if the external device 100 is connected with the interface 23 of the computer 24.

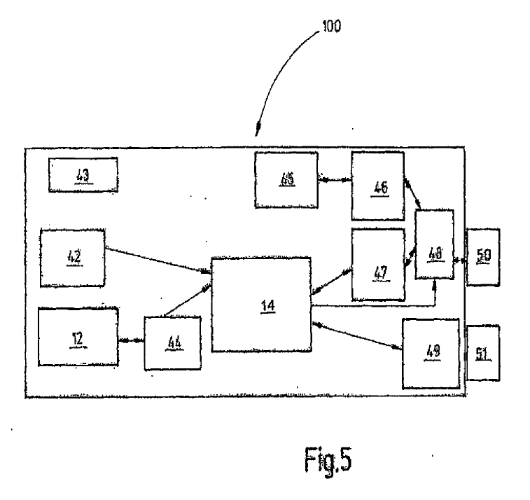

FIG. 5 shows a block schematic of the external device 100. The blocks shown in FIG. 5 are functional modules that do not necessarily have to correspond to separate physical modules. An individual functional module could be implemented in the external device by means of multiple physical modules. Furthermore, it would be possible to implement multiple functional modules with a single physical module. A processor 14 serves as the central control element of the external device 100. The processor 14 controls the data and program sequence within the external device 100 and has corresponding interfaces to the individual functional units. In this connection, a microprogram that runs on the processor controls the functionality of the external device 100 as well as the communication with the connected computer 24 or the network. For this purpose, the microprocessor 14 can contain non-volatile memory, for example ROM or flash, as well as volatile memory, for example SRAM. The fingerprint sensor 12 serves for detecting the fingerprint, whereby the processor 14 compares the detected fingerprint with the fingerprint characteristics that are stored on a flash module 44. The ID identification unit 42 serves for generation of a worldwide unique identification ID (identification code). A further flash module 45 essentially contains user data of one or more users of the external device 100. Various data concerning the user or the user behavior can be stored on this module. For example, it is possible to store desktop data such as screen background images, symbols for faster call-up of frequently used programs, as well as links to user-specific data in this memory. As a result, after successful identification of the user with the computer 24 or the computer network, the user can work with a familiar desktop environment and store possible changes for a subsequent log-in. These data are transmitted to the USB interface 50 by the flash, by way of a USB driver module 46, by way of a multiplexer 48, in order to transmit the data to a connected computer 24. A further USB driver module 47 serves for transmission of the data by the processor 14. Furthermore, the external device 100 provides a wireless module 49 that communicates with other devices, for example computer, computer network, network router, or other receiver devices, by way of wireless transmission technology, for example Bluetooth or WLAN, by way of the wireless interface 51. A power supply unit 43 serves to supply voltage during extended use off the grid. The power supply unit 43 is preferably implemented by means of one or more rechargeable batteries. Alternatively, the power supply device 43 can also have battery cells, for example. The external device 100, particularly the internal real-time clock (not shown in the figure) is supplied with voltage, during use off the grid, by means of the power supply unit 43. Here, use off the grid is understood to mean use of the external device 100 by way of the wireless interface 51 as well as non-use of the external device. During USB operation, i.e. during use of the external device 100 by way of the USB interface 50, the external device is preferably supplied with voltage by the computer 24. In this connection, it is provided that the internal voltage source, for example rechargeable battery, is recharged at the USB interface during use. The internal voltage supply unit 43 can be disposed within the external device 100 and also in a cover cap of the external device 100. A usual cap of a USB stick, for example, would be possible as a cover cap. In this connection, this cap would have a rechargeable battery for supplying voltage to the external device 100 during use off the grid. During operation of the external device 100 by way of the USB interface 50, the cap could be connected with the external device in suitable manner, for the purpose of charging the rechargeable battery. Further possible functional blocks such as, for example, an RFID chip, a proximity sensor, or a temperature sensor are not shown in FIG. 5.

### REFERENCE SYMBOLS

100 external device
9 computer program
10 housing
11 USB plug
12 fingerprint sensor
12a scanner surface
12b biometric means
13 proximity sensor
14 processor
15 USB drive
16 fixed-value memory
17 working memory
18 WLAN connection
19 data line
20 data line
21 data line
22 data line
23 interface
24 computer
24a computer program
25 processor
26 fixed-value memory
27 working memory
28 input/output
29 peripheral device
30 peripheral device
31 peripheral device
32 data line
33 data line
34 data line
35 data line
36 data line
37 connection
38 connection
39 data line
40 data line
41 data line
42 ID identification unit
43 power supply unit
44 memory module
45 memory module
46 USB driver module
47 USB driver module
48 multiplexer
49 wireless module
50 USB IF
51 wireless IF

1. External device (100) having at least one memory, which device can be connected with a computer (24) or computer network by way of a serial bus system, wherein it has a processor (14) as well as a USB drive (15) and a biometric means (12b) for identification of a person, wherein processor (14), USB drive (15), and biometric means (12b) are coupled with one another.

2. Device according to claim 1, wherein the means (12b) is a fingerprint sensor (12).

3. Device according to claim 1, wherein it has a chip.

4. Device according to claim 3, wherein the chip is an RFID chip.

5. Device according to claim 1, wherein it comprises means for temperature detection.

6. Device according to claim 1, wherein it is provided with a USB plug (11).

7. Device according to claim 1, wherein it has an Internet access.

8. Device according to claim 7, wherein the access is a WLAN access (18).

9. Device according to claim 1, wherein it has a proximity sensor (13).

10. Device according to claim 1, wherein it has at least one memory in the form of a working memory (17) and/or fixed-value memory (16).

11. Device according to claim 1, wherein it is provided with a housing (10).

12. Device according to claim 1, wherein it has the construction shape of a USB stick.

13. Device according to claim 1, wherein the external device (100) has an ID identification unit (42).

14. Device according to claim 1, wherein the external device (100) has a wireless interface (51), particularly a WLAN and/or a Bluetooth interface.

15. Device according to claim 1, wherein the external device (100) has a power supply unit (43).

16. Device according to claim 1, wherein user data, preferably desktop data, or one or more users are stored in the external device (100).

17. Method for verification of access entitlement of a user of a computer (24) or of a computer network, wherein biometric data of the user can be detected and recognized for verification, by means of a biometric means (12b) of an external device (100) having at least one memory, which device can be connected with a computer (24) or computer network by way of a serial bus system, wherein it has a processor (14) as well as a USB drive (15) and a biometric means (12b) for identification of a person, wherein processor (14), USB drive (15), and biometric means (12b) are coupled with one another.

18. Method according to claim 17, wherein the device (100) has a means for temperature detection and/or that the means (12b) is a fingerprint sensor (12).

19. Method according to claim 17, wherein the device (100) has a chip, preferably an RFID chip.

20. Method according to claim 17, wherein the method has the following steps for user identification:
a) Connection of the external device (100) with a computer (24) or computer network.
b) Reading in of a physiological characteristic, particularly a fingerprint, by means of the external device (100).
c) Checking of the physiological characteristic as well as of an identification code generated in the external device (100) by means of the external device (100), particularly by means of a processor (14) in the device (100).
d) Transmission of the physiological characteristic as well as of the identification code to the computer (24) or computer network.
e) Checking of the physiological characteristic as well as of the identification code by the computer or the computer network.
f) Release of access by the identified user to specific data and/or programs on the computer (24) or the computer network.

21. Computer program (9) for a computer facility in the form of a computer (24) or computer network, which facility can be used with an external device (100) according to claim 1, wherein the computer program (9) contains an algorithm that is processed by a processor (25) of the computer facility when a connection exists between the computer facility and the external device (100), wherein the algorithm uses a method for the verification of access entitlement of a user of a computer (24) or of a computer network, wherein biometric data of the user can be detected and recognized for verification, by means of a biometric means (12b) of an external device (100).
